(19) United States
(12) Patent Application Publication
(10) Pub. No.: US 2025/0285258 A1
(43) Pub. Date: Sep. 11, 2025

(54) SYSTEM, METHOD AND APPARATUS FOR DETECTING MEANDERING FAULT OF ELECTRODE TABS IN SECONDARY BATTERY

(71) Applicant: SK ON CO., LTD., Seoul (KR)

(72) Inventors: Yu Ri SONG, Daejeon (KR); Do Young KIM, Daejeon (KR); Ung Bae PARK, Daejeon (KR); Byoung Hak LEE, Daejeon (KR); Jung Taek LIM, Daejeon (KR); Byung Wook JANG, Daejeon (KR); Young Jin JANG, Daejeon (KR)

(21) Appl. No.: 19/025,916

(22) Filed: Jan. 16, 2025

(30) Foreign Application Priority Data
Mar. 8, 2024 (KR) 10-2024-0033262

(51) Int. Cl. G06T 7/00; H01M 10/42

(52) U.S. Cl. CPC G06T 7/0006; H01M 10/4285; G06T 2207/30108

(57) ABSTRACT

The present disclosure relates to a system, method and apparatus for detecting a meandering fault of electrode tabs of a secondary battery. The method according to an embodiment of the present disclosure includes: photographing an electrode tab area of the secondary battery through a camera; measuring exposure lengths of a sealing film located between the electrode tab and a pouch film at two designated points from an image obtained by photographing the electrode tab area; checking whether an absolute value of a difference between the measured exposure lengths is a designated reference value or more; and if the absolute value is the reference value or more, determining that the meandering fault of electrode tabs has occurred.

### CROSS-REFERENCE TO RELATED APPLICATION

This application claims priority to Korean Patent Application No. 10-2024-0033262 filed Mar. 8, 2024, the disclosure of which is hereby incorporated by reference in its entirety.

### BACKGROUND OF THE INVENTION

### 1. Field of the Invention

The present disclosure relates to a system, method and apparatus for detecting a meandering fault of electrode tabs in a secondary battery.

### 2. Description of the Related Art

A secondary battery is a battery that can be repeatedly charged and discharged. With rapid progress of information and communication, and display industries, the secondary battery has been widely applied to various portable electronic telecommunication devices such as a camcorder, a mobile phone, a smart phone, a tablet personal computer (PC), a laptop PC, etc. as a power source thereof. Recently, a battery pack including the secondary battery has also been developed as a power source of an eco-friendly automobile such as an electric vehicle.

Meanwhile, various defects or faults may occur in the secondary battery during manufacturing. For example, a meandering fault of electrode tabs may occur during a manufacturing process of an electrode (e.g., electrode assembly) of the battery cell. Currently, a worker manually detects the meandering fault of electrode tabs visually or using measurement equipment. Due to this, there is a problem that a productivity of the manufacturing process of the secondary battery is decreased (e.g., an inspection time increases).

### SUMMARY OF THE INVENTION

According to one aspect of the present disclosure, it is an object to provide a system, method and apparatus for detecting a meandering fault of electrode tabs of a secondary battery capable of improving efficiency of meandering fault detection.

According to another aspect of the present disclosure, it is an object to provide a system, method and apparatus for detecting a meandering fault of electrode tabs of a secondary battery capable of improving accuracy of meandering fault detection.

To achieve the above objects, according to an aspect of the present invention, there is provided a method for detecting a meandering fault of electrode tabs of a secondary battery, which includes: photographing an electrode tab area of the secondary battery through a camera; measuring exposed lengths of a sealing film located between the electrode tab and a pouch film at two designated points from an image obtained by photographing the electrode tab area; checking whether an absolute value of a difference between the measured exposed lengths is a designated reference value or more; and if the absolute value is the reference value or more, determining that the meandering fault of electrode tabs has occurred.

According to an embodiment, the measuring step may include: detecting an upper edge of the electrode tab, a lower edge of the electrode tab, a first boundary line between the electrode tab and the sealing film, and a second boundary line between the sealing film and the pouch film; measuring a first exposed length between the first boundary line and the second boundary line at a first point spaced apart from the upper edge of the electrode tab toward the lower edge by a designated distance; and measuring a second exposed length between the first boundary line and the second boundary line at a second point spaced apart from the lower edge of the electrode tab toward the upper edge by the designated distance.

According to an embodiment, the step of detecting a first boundary line may include: detecting a plurality of boundary points in an upward direction and a downward direction of the first point or the second point; and generating the first linear boundary line based on the plurality of detected boundary points through line fitting.

According to an embodiment, the step of detecting a second boundary line may include: detecting a plurality of boundary points between the sealing film and the pouch film; and generating the second linear boundary line based on the plurality of detected boundary points through line fitting.

According to an embodiment, the photographing step may include: photographing a cathode tab area of the electrode tab area and an anode tab area of the electrode tab area; and synthesizing a first image obtained by photographing the cathode tab area and a second image obtained by photographing the anode tab area.

According to an embodiment, the method may further include generating an alarm in a designated manner when it is determined that the meandering fault has occurred.

According to an embodiment, the method may further include recognizing a degree of meandering of the electrode tab based on the difference between the exposed lengths.

According to another aspect of the present invention, there is provided an apparatus for detecting a meandering fault of electrode tabs of a secondary battery, which includes: a camera configured to photograph an electrode tab area of a secondary battery; and a processor configured to measure exposed lengths of a sealing film located between the electrode tab and a pouch film at two designated points from an image obtained by photographing the electrode tab area, checking whether an absolute value of a difference between the measured exposed lengths is a designated reference value or more, and if the absolute value is the reference value or more, determine that the meandering fault of electrode tabs has occurred.

According to an embodiment, the processor may detect an upper edge of the electrode tab, a lower edge of the electrode tab, a first boundary line between the electrode tab and the sealing film, and a second boundary line between the sealing film and the pouch film, measure a first exposed length between the first boundary line and the second boundary line at a first point spaced apart from the upper edge of the electrode tab toward the lower edge by a designated distance, measure a second exposed length between the first boundary line and the second boundary line at a second point spaced apart from the lower edge of the electrode tab toward the upper edge by the designated distance, and compare the first exposed length and the second exposed length to calculate an absolute value of the difference.

According to an embodiment, the processor may detect a plurality of boundary points in an upward direction and a downward direction of the first point or the second point, and generate the first linear boundary line based on the plurality of detected boundary points through line fitting.

According to an embodiment, the processor may detect a plurality of boundary points between the sealing film and the pouch film, and generate the second linear boundary line based on the plurality of detected boundary points through line fitting.

According to an embodiment, the electrode tab area may include a cathode tab area and an anode tab area. The camera may photograph the cathode tab area and the anode tab area, respectively.

According to an embodiment, the processor may synthesize a first image obtained by photographing the cathode tab area and a second image obtained by photographing the anode tab area, and measure the exposed lengths at the two designated points based on the synthesized image.

According to an embodiment, the apparatus may further include an alarm module configured to generate an alarm in a designated manner when the meandering fault occurs.

According to an embodiment, the processor may recognize a degree of meandering of the electrode tab based on the difference between the exposed lengths.

In addition, according to another aspect of the present invention, there is provided a system for detecting a meandering fault of electrode tabs of a secondary battery, including: a transfer system configured to transfer a secondary battery; and an inspection system configured to photograph an electrode tab area of the a secondary battery transferred through the transfer system using a camera, measure exposed lengths of a sealing film located between the electrode tab and a pouch film at two designated points from an image obtained by photographing the electrode tab area, and inspect whether there is a meandering fault of electrode tabs based on the measured exposed lengths.

According to an embodiment, the present disclosure may improve the efficiency of meandering fault detection. For example, the present disclosure may automatically detect a meandering fault of electrode tabs by using an image recognition technique, and improve the efficiency of meandering fault detection.

In addition, the present disclosure may improve the accuracy of meandering fault detection. For example, the present disclosure may prevent measurement errors in the exposed lengths through line fitting, and improve the accuracy of meandering fault detection.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a system for detecting a meandering fault of electrode tabs of a secondary battery according to an embodiment of the present disclosure;

FIG. 2A is a view illustrating the structure of the secondary battery according to an embodiment of the present disclosure;

FIG. 2B is a cross-sectional view illustrating a secondary battery according to another embodiment of the present disclosure;

FIG. 3 is a flowchart for describing producers of a method for detecting a meandering fault of electrode tabs of a secondary battery according to an embodiment of the present disclosure;

FIG. 4A is an exemplary view illustrating an example of an image captured when a meandering fault of electrode tabs does not occur according to an embodiment of the present disclosure;

FIG. 4B is an exemplary view illustrating an example of an image captured when a meandering fault of electrode tabs occurs according to an embodiment of the present disclosure;

FIG. 5 is a view for describing a technical effect when measuring exposed lengths using a boundary line according to an embodiment of the present disclosure;

FIG. 6 is a view for describing measurement points for measuring exposed lengths of a sealing film according to an embodiment of the present disclosure; and

FIG. 7 is a block diagram illustrating the configuration of an apparatus for detecting a meandering fault of electrode tabs of a secondary battery according to an embodiment of the present disclosure.

### DETAILED DESCRIPTION OF THE INVENTION

Hereinafter, the present disclosure will be described in detail through embodiments with reference to the accompanying drawings. However, the embodiments are merely illustrative and the present disclosure is not limited to the specific embodiments described by way of example.

Although a first, a second, and the like are used to describe various elements, components and/or sections, these elements, components and/or sections are of course not limited by these terms. These terms are merely used to distinguish one element, component and/or section from another element, component and/or section. Therefore, it goes without saying that the first element, first component or first section mentioned below may also be the second element, second component or second section within the technical spirit of the present disclosure.

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than those mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

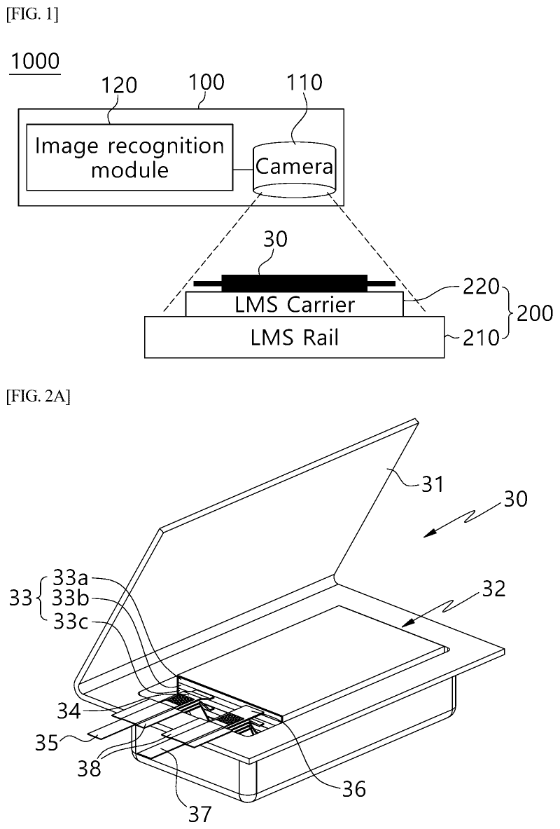

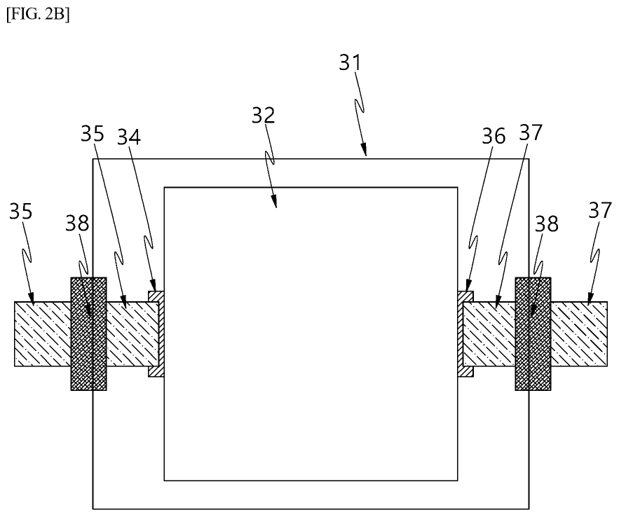

FIG. 1 is a schematic view illustrating a system for detecting a meandering fault of electrode tabs of a secondary battery according to an embodiment of the present disclosure, FIG. 2A is a view illustrating the structure of the secondary battery according to an embodiment of the present disclosure, and FIG. 2B is a cross-sectional view illustrating a secondary battery according to another embodiment of the present disclosure.

Referring to FIGS. 1 to 2B, a system 1000 according to an embodiment of the present disclosure may detect a meandering fault of electrode tabs of a secondary battery 30.

Before a detailed description of the system 1000 according to the present disclosure, the structure of the secondary battery 30 will be described. As shown in FIGS. 2A and 2B, the secondary battery 30 may include a pouch film 31, an electrode assembly 32, a battery cell 33, a cathode lead 34, a cathode tab 35, an anode lead 36, an anode tab 37, and a sealing film 38.

The pouch film 31 is a case of the secondary battery 30, and may include (e.g., house) the electrode assembly 32. For example, the pouch film 31 may include a space (e.g., a main chamber) in which the electrode assembly 32 is housed. Meanwhile, the pouch film 31 may be referred to as a pouch case, a cell case, etc.

The electrode assembly 32 may include the battery cell 33 including a cathode 33a, a separation membrane 33b and an anode 33c, cathode leads 34 and the cathode tab 35 electrically connected to the cathode 33a of the battery cell 33, and anode leads 36 and the anode tab 37 electrically connected to the anode 33c. At this time, the cathode leads 34 and the cathode tab 35 may be coupled by welding (e.g., ultrasonic welding), and the anode leads 36 and the anode tab 37 may also be coupled by welding. In addition, a portion of each of the cathode tab 35 and the anode tab 37 may protrude to an outside of the pouch film 31. The cathode tab 35 and the anode tab 37 may be located together on one side of the electrode assembly 32, as shown in FIG. 2A. Alternatively, the cathode tab 35 and the anode tab 37 may be located on both sides (e.g., opposite sides) of the electrode assembly 32, as shown in FIG. 2B.

The sealing film 38 may wrap a portion of the cathode tab 35 and the anode tab 37. For example, the sealing film 38 may include a first sealing film wrapping a portion of the cathode tab 35 and a second sealing film wrapping a portion of the anode tab 37. The sealing film 38 may be called a sealant, a sealant film, etc.

The sealing film 38 may be a modified polyolefin-based insulation material. The sealing film 38 may be located between the pouch film 31 and the electrode tabs 35 and 37, and may block electrical connection between the pouch film 31 and the electrode tabs 35 and 37. In addition, the sealing film 38 may have adhesion. The sealing film 38 may seal the pouch film 31 to prevent an electrolyte from leaking to the outside.

Meanwhile, FIGS. 2A and 2B illustrates the stacked-type secondary battery 30 in which a plurality of battery cells 33 are stacked, but it is not limited thereto, and the present disclosure may be applied to secondary batteries of various types (e.g., a jelly-roll type in which a plurality of battery cells 33 are rolled up in a jelly-roll shape).

The system 1000 for detecting a meandering fault of electrode tabs of the secondary battery 30 according to an embodiment of the present disclosure may include an inspection system 100 and a transfer system 200.

The transfer system 200 may transfer the secondary battery 30. For example, the transfer system 200 may control transfer according to process procedures for manufacturing the secondary battery 30. In addition, the transfer system 200 may control transfer of the secondary battery 30 (e.g., transfer the secondary battery 30 to a lower side of a camera 110 of the inspection system 100) for inspection of the secondary battery 30 (e.g., inspection of the meandering fault). The transfer system 200 may include a linear motion system (LMS). The transfer system 200 may include a rail 210 forming a travel path and a carrier 220 having the secondary battery 30 placed on an upper surface thereof and moving along the rail 210.

The inspection system 100 may capture an image of at least a partial area (e.g., an electrode tab area) of the secondary battery 30, and analyze the captured image to inspect whether the secondary battery 30 is defective. For example, the inspection system 100 may measure exposed lengths of a sealing film at two designated points from the image obtained by photographing the electrode tab area of the secondary battery 30, and inspect whether there is a meandering fault of electrode tabs of the secondary battery 30 based on the measured exposed lengths. According to an embodiment, the inspection system 100 may include the camera 110 and an image recognition module 120.

The camera 110 may be located above the transfer system 200. The camera 110 may photograph at least a partial area of the secondary battery 30 placed on the carrier 220 of the transfer system 200. For example, the camera 110 may photograph an electrode tab (cathode tab and/or anode tab) area of the secondary battery 30. According to some embodiments, the camera 110 may include a first camera (not shown) configured to photograph a cathode tab area and a second camera (not shown) configured to photograph an anode tab area. In this case, images captured by the first camera and the second camera may be synthesized into one image, and then detection of a meandering fault may be performed through image recognition.

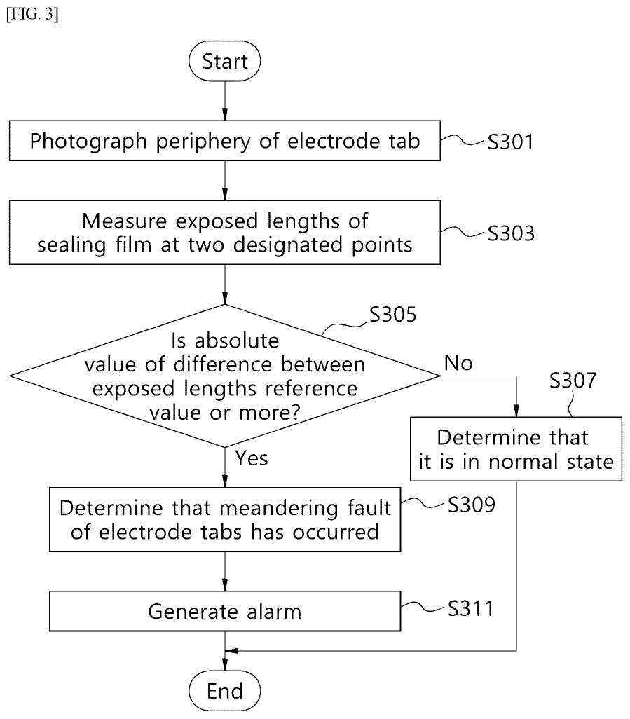

The image recognition module 120 may detect (e.g., determine) whether there is a meandering fault of electrode tabs of the secondary battery 30 from the image captured by the camera 110. For example, the image recognition module 120 may measure exposed lengths of the sealing film located between the electrode tab and the pouch film at two designated points from the image obtained by photographing the electrode tab area, and compare an absolute value of a difference between the measured exposed lengths with a designated reference value to detect (e.g., determine) whether there is a meandering fault of electrode tabs. The image recognition module 120 may include an artificial intelligence model based on deep learning. An operation of the image recognition module 120 will be described in detail below with reference to FIGS. 3 to 6.

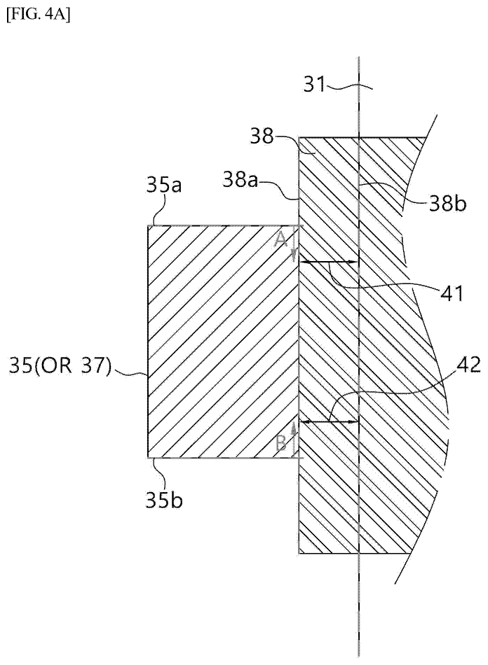

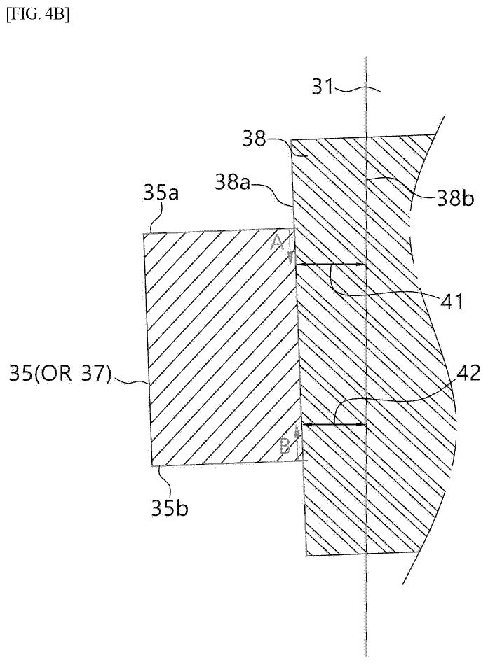

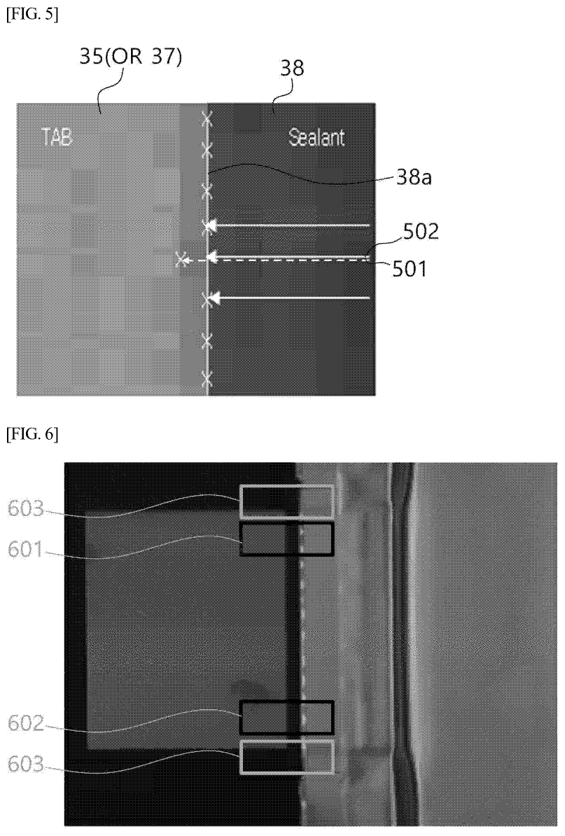

FIG. 3 is a flowchart for describing producers of a method for detecting a meandering fault of electrode tabs of a secondary battery according to an embodiment of the present disclosure, FIG. 4A is an exemplary view illustrating an example of an image captured when a meandering fault of electrode tabs does not occur according to an embodiment of the present disclosure, FIG. 4B is an exemplary view illustrating an example of an image captured when a meandering fault of electrode tabs occurs according to an embodiment of the present disclosure, FIG. 5 is a view for describing a technical effect when measuring exposed lengths using a boundary line according to an embodiment of the present disclosure, and FIG. 6 is a view for describing measurement points for measuring exposed lengths of a sealing film according to an embodiment of the present disclosure.

Referring to FIGS. 3 to 6, the method for detecting a meandering fault of electrode tabs of a secondary battery according to an embodiment of the present disclosure may include a step S301 of photographing a periphery of an electrode tab. For example, the inspection system 100 may photograph a periphery of the electrode tab (e.g., the cathode tab 35 and the anode tab 37) of the secondary battery 30 using the camera 110. The inspection system 100 may photograph the periphery of the electrode tab of the secondary battery 30 based on blue lighting. According to some embodiments, the inspection system 100 may photograph the cathode tab 35 area and the anode tab 37 area, respectively, through the camera 110. Alternatively, the inspection system 100 may include the first camera (not shown) configured to photograph the cathode tab 35 area and the second camera (not shown) configured to photograph the anode tab 37 area.

The method may include a step S303 of measuring exposed lengths of the sealing film at two designated points. For example, the image recognition module 120 of the inspection system 100 may detect boundary lines (or edges) of the electrode tab, the sealing film, and the pouch film of the secondary battery from the image obtained by photographing the electrode tab area, and may measure the exposed lengths of the sealing film at two designated points based on the detected boundary lines. Specifically, the image recognition module 120 may detect an upper edge 35a of the electrode tab (the cathode tab 35 or the anode tab 37), a lower edge 35b of the electrode tab, a first boundary line 38a between the electrode tab and the sealing film 38, and a second boundary line 38b between the sealing film 38 and the pouch film 31 from the image obtained by photographing the electrode tab area, as shown in FIGS. 4A and 4B. Thereafter, the image recognition module 120 may measure a first exposed length 41 between the first boundary line 38a and the second boundary line 38b at a first point A spaced apart from the upper edge 35a of the electrode tab toward the lower edge 35b by a designated distance (e.g., 5 mm), and may measure a second exposed length 42 between the first boundary line 38a and the second boundary line 38b at a second point B spaced apart from the lower edge 35b of the electrode tab toward the upper edge 35a by the designated distance. Meanwhile, when the cathode tab 35 area and the anode tab 37 area are photographed separately, the image recognition module 120 of the inspection system 100 may synthesize (e.g., synthesize using a photometric technique) a first image obtained by photographing the cathode tab 35 area and a second image obtained by photographing the anode tab 37 area, and measure the first exposed length 41 and the second exposed length 42 based on the synthesized image.

According to an embodiment, the image recognition module 120 may detect a plurality of boundary points (e.g., boundary points between the electrode tab (the cathode tab 35 or the anode tab 37) and the sealing film 38) in an upward direction and a downward direction based on one point (e.g., the first point A or the second point B) as shown in FIG. 5, and may generate a first linear boundary line 38a based on the detected plurality of boundary points through line fitting. Through this, the present disclosure may more accurately measure the exposed lengths of the sealing film 38. In other words, when the exposed length is measured based on the boundary point detected at a specific position without generating the first boundary line, the exposed length may vary depending on the measurement positions 501, 502 and 503, as shown in FIG. 5. For example, as indicated by a dotted arrow of a reference numeral 501 in FIG. 5, the exposed length at the second measurement position 502 may be measured larger than the actual size. On the other hand, when the exposed length is measured based on the first boundary line 38a as in the present disclosure, the exposed length at the second measurement position 502 may be accurately measured, as indicated by a solid arrow of a reference numeral 502 in FIG. 5. Similarly, the image recognition module 120 may generate the second boundary line 38b.

According to an embodiment, to measure the exposed lengths of the sealing film 38 by the image recognition module 120, as shown in FIG. 6, the first point A may be included in a first range 601 spaced apart from an upper edge 35a of the electrode tab by a designated length (e.g., 5 mm), and a second point B may be included in a second range 602 spaced apart from a lower edge 35b of the electrode tab by a designated length. The reason is that, at the upper edge 35a of the electrode tab and the lower edge 35b of the electrode tab, colors (e.g., black) of the sealing film 38 and the background are similar to each other, thereby making it difficult to recognize an outer boundary of the sealing film 38, as shown in a reference numeral 603 of FIG. 6. The designated length may be variable.

The method may include a step S305 of checking whether the absolute value of the difference between the exposed lengths is a designated reference value or more. For example, the image recognition module 120 of the inspection system 100 may calculate a difference between the first exposed length 41 and the second exposed length 42, and check whether the absolute value of the calculated difference is the designated reference value (e.g., 1 mm) or more.

As a result of the check in the step S305, if the absolute value of the difference between the exposed lengths is not the designated reference value or more, the method may proceed to a step S307 of determining that it is in a normal state. In other words, the image recognition module 120 may determine that the meandering fault of electrode tabs does not occur. For example, as shown in FIG. 4A, if the first exposed length 41 and the second exposed length 42 are similar to each other, the image recognition module 120 may determine that the electrode tab is in a normal state.

On the other hand, as a result of the check in the step S305, if the absolute value of the difference between the exposed lengths is the designated reference value or more, the method may proceed to a step S309 of determining that the meandering fault of electrode tabs has occurred. In other words, the image recognition module 120 may determine that the meandering fault of electrode tabs has occurred. For example, as shown in FIG. 4B, if the first exposed length 41 is greater than the second exposed length 42 by a designated reference value or more, the image recognition module 120 may determine that the meandering fault of electrode tabs has occurred. Meanwhile, the image recognition module 120 may recognize a degree of the meandering of the electrode tab based on the difference between the first exposed length 41 and the second exposed length 42.

The method may include a step S311 of generating an alarm. For example, the image recognition module 120 of the inspection system 100 may generate an alarm to notify the meandering fault of electrode tabs in a designated manner (e.g., a visual alarm (e.g., light emitting diode (LED) lighting, icon display, pop-up window display, etc.), an auditory alarm (e.g., sound effect output) and/or a tactile alarm (e.g., vibration generation).

Meanwhile, although not shown in FIG. 3, the method may further include a step of preprocessing (e.g., increasing brightness, increasing contrast, enhancing contrast, etc.) the image captured after step S301 to be suitable for boundary recognition. In addition, the method may further include a step of transmitting an alarm to notify an occurrence of the meandering fault of electrode tabs to a designated external device (e.g., a smart phone of a manager) through a communication module.

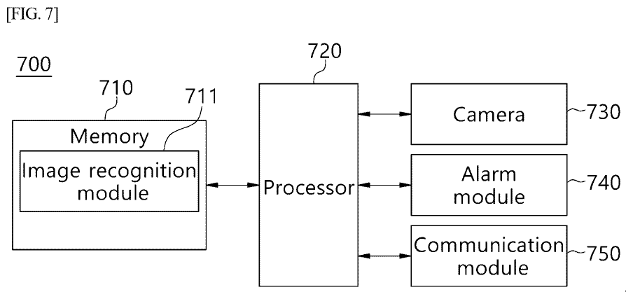

FIG. 7 is a block diagram illustrating the configuration of an apparatus for detecting a meandering fault of electrode tabs of a secondary battery according to an embodiment of the present disclosure.

Referring to FIG. 7, an apparatus (hereinafter, a detection apparatus) 700 for detecting a meandering fault of electrode tabs of a secondary battery according to an embodiment of the present disclosure may be the inspection system 100 of FIG. 1. However, the detection apparatus 700 may be installed in conjunction with the transfer system 200, or may be installed separately.

According to an embodiment, the detection apparatus 700 may include a memory 710, a processor 720, a camera 730, an alarm module 740, and a communication module 750.

The memory 710 may store a program that controls an operation of the detection apparatus 700 and/or information necessary to control the operation of the detection apparatus 700. According to an embodiment, the memory 710 may store an image recognition module 711.

The image recognition module 711 may be the same as or similar to the image recognition module 120 of FIG. 1, and therefore will not be described in detail. According to an embodiment, the image recognition module 711 may include an artificial intelligence model based on deep learning. The artificial intelligence model may be trained based on various images in order to accurately measure the exposed lengths of the sealing film from the image obtained by photographing the electrode tab area.

The processor 720 may control an overall operation of the detection apparatus 700. For example, the processor 720 may receive commands or instructions from the memory 710, and control each component according to the received commands or instructions to perform various functions. The processor 720 may be formed of a central processing unit (CPU), a micro control unit (MCU), a micro processor unit (MPU) and the like.

According to an embodiment, the processor 720 may check whether there is a meandering fault of electrode tabs using the image recognition module 711. The method for checking whether there is a meandering fault of electrode tabs has been described in FIGS. 3 to 6, and therefore the specific operation of the processor 720 will not be described.

The camera 730 may photograph a subject. For example, the camera 730 may photograph at least a partial area of the secondary battery (e.g., the electrode tab area) to be inspected for a meandering fault.

When a designated condition is satisfied, the alarm module 740 may generate an alarm in the designated manner. For example, when a meandering fault of electrode tabs is detected, the alarm module 740 may generate an alarm. The alarm module 740 may generate at least one of a visual alarm (e.g., light emitting diode (LED) lighting, icon display, pop-up window display, etc.), an auditory alarm (e.g., sound effect output) and/or a tactile alarm (e.g., vibration generation). To this end, the alarm module 740 may include at least one of a light emitting diode, a display, a speaker, and a vibration motor.

The communication module 750 may communicate with an external device (e.g., the transfer system 200 of FIG. 1, a portable terminal (e.g., a smart phone) of the manager) via wired communication or wireless communication. For example, the communication module 750 may receive an inspection request for a meandering fault of electrode tabs from the transfer system 200. In addition, when the inspection is completed, the communication module 750 may notify the transfer system 200 of the completion of the inspection. The transfer system 200 that has been notified of the completion of the inspection may transfer the secondary battery, on which the inspection is completed, to a position where the next process is to be performed. As another example, the communication module 750 may transmit an alarm to notify an occurrence of the meandering fault of electrode tabs to the designated external device (e.g., the smart phone of the manager).

Meanwhile, the detection apparatus 700 may not include some of the above-described configurations, or may further include other configurations. For example, the detection apparatus 700 may not include the alarm module 740 and/or the communication module 750. As another example, the detection apparatus 700 may further include an input module and/or a display for receiving the input of a user. Alternatively, some of the configurations of the detection apparatus 700 may be configured separately. For example, if the image recognition module 711 of the detection apparatus 700 is an artificial intelligence model, the image recognition module 711 may be included in an external server (e.g., an artificial intelligence server).

The contents described above are merely an example to which the principles of the present disclosure are applied, and other configurations may be further included in the present disclosure without departing from the scope of the present invention. For example, at least some of the above-described various embodiments of the present disclosure may be combined.

What is claimed is:

1. A method for detecting a meandering fault of electrode tabs of a secondary battery, the method comprising:
photographing an electrode tab area of the secondary battery through a camera;
measuring exposed lengths of a sealing film located between the electrode tab and a pouch film at two designated points from an image obtained by photographing the electrode tab area;
checking whether an absolute value of a difference between the measured exposed lengths is a designated reference value or more; and
if the absolute value is the reference value or more, determining that the meandering fault of electrode tabs has occurred.

2. The method according to claim 1, wherein the measuring step comprises:
detecting an upper edge of the electrode tab, a lower edge of the electrode tab, a first boundary line between the electrode tab and the sealing film, and a second boundary line between the sealing film and the pouch film;
measuring a first exposed length between the first boundary line and the second boundary line at a first point spaced apart from the upper edge of the electrode tab toward the lower edge by a designated distance; and
measuring a second exposed length between the first boundary line and the second boundary line at a second point spaced apart from the lower edge of the electrode tab toward the upper edge by the designated distance.

3. The method according to claim 2, wherein the step of detecting a first boundary line comprises:
detecting a plurality of boundary points in an upward direction and a downward direction of the first point or the second point; and
generating the first linear boundary line based on the plurality of detected boundary points through line fitting.

4. The method according to claim 2, wherein the step of detecting a second boundary line comprises:
detecting a plurality of boundary points between the sealing film and the pouch film; and
generating the second linear boundary line based on the plurality of detected boundary points through line fitting.

5. The method according to claim 1, wherein the photographing step comprises:
photographing a cathode tab area of the electrode tab area and an anode tab area of the electrode tab area; and
synthesizing a first image obtained by photographing the cathode tab area and a second image obtained by photographing the anode tab area.

6. The method according to claim 1, further comprising generating an alarm in a designated manner when it is determined that the meandering fault has occurred.

7. The method according to claim 1, further comprising recognizing a degree of meandering of the electrode tab based on the difference between the exposed lengths.

8. An apparatus for detecting a meandering fault of electrode tabs of a secondary battery, the apparatus comprising:
a camera configured to photograph an electrode tab area of a secondary battery; and
a processor configured to measure exposed lengths of a sealing film located between the electrode tab and a pouch film at two designated points from an image obtained by photographing the electrode tab area, checking whether an absolute value of a difference between the measured exposed lengths is a designated reference value or more, and if the absolute value is the reference value or more, determine that the meandering fault of electrode tabs has occurred.

9. The apparatus according to claim 8, wherein the processor
detects an upper edge of the electrode tab, a lower edge of the electrode tab, a first boundary line between the electrode tab and the sealing film, and a second boundary line between the sealing film and the pouch film,
measures a first exposed length between the first boundary line and the second boundary line at a first point spaced apart from the upper edge of the electrode tab toward the lower edge by a designated distance,
measures a second exposed length between the first boundary line and the second boundary line at a second point spaced apart from the lower edge of the electrode tab toward the upper edge by the designated distance, and
compares the first exposed length and the second exposed length to calculate an absolute value of the difference.

10. The apparatus according to claim 9, wherein the processor
detects a plurality of boundary points in an upward direction and a downward direction of the first point or the second point, and
generates the first linear boundary line based on the plurality of detected boundary points through line fitting.

11. The apparatus according to claim 9, wherein the processor
detects a plurality of boundary points between the sealing film and the pouch film, and
generates the second linear boundary line based on the plurality of detected boundary points through line fitting.

12. The apparatus according to claim 8, wherein the electrode tab area includes a cathode tab area and an anode tab area, and
the camera photographs the cathode tab area and the anode tab area, respectively.

13. The apparatus according to claim 12, wherein the processor synthesizes a first image obtained by photographing the cathode tab area and a second image obtained by photographing the anode tab area, and measures the exposed lengths at the two designated points based on the synthesized image.

14. The apparatus according to claim 8, further comprising an alarm module configured to generate an alarm in a designated manner when the meandering fault occurs.

15. The apparatus according to claim 8, wherein the processor recognizes a degree of meandering of the electrode tab based on the difference between the exposed lengths.

16. A system for detecting a meandering fault of electrode tabs of a secondary battery, comprising:
a transfer system configured to transfer a secondary battery; and
an inspection system configured to photograph an electrode tab area of the a secondary battery transferred through the transfer system using a camera, measure exposed lengths of a sealing film located between the electrode tab and a pouch film at two designated points from an image obtained by photographing the electrode tab area, and inspect whether there is a meandering fault of electrode tabs based on the measured exposed lengths.
